(19) United States
(12) Patent Application Publication
(10) Pub. No.: US 2026/0006052 A1
(43) Pub. Date: Jan. 1, 2026

(54) PROTECTED TRAINING OF PRIVATE ADAPTER MODELS FOR A HOSTED FOUNDATION MODEL

(71) Applicant: CrowdStrike, Inc., Sunnyvale, CA (US)

(72) Inventors: Marian Radu, Bucharest (RO); Paul Sumedrea, Bucharest (RO)

(21) Appl. No.: 18/759,438

(22) Filed: Jun. 28, 2024

(51) Int. Cl. H04L 9/40; G06N 20/00

(52) U.S. Cl. CPC H04L 63/1425; G06N 20/00

(57) ABSTRACT

Methods and systems are provided for training copies of a private adapter network at respective client computing devices; and aggregating of trained weight sets in a common parameter space as a weight set of a hosted foundation model at a cloud computing system. A private adapter model can be a subdivision of a hosted foundation model, segmented from some number of layers of a hosted foundation model or can be distinct from the hosted foundation model, given that the private adapter model configures a computing host to update a weight set in a common parameter space as a weight set of the hosted foundation model. By performing a protected update to a weight set, true values of the coefficients of the weight set derived from inputting features of a labeled dataset at a first layer of the private adapter model are obfuscated.

### BACKGROUND

In the field of cybersecurity, it is challenging for network administrators, cybersecurity researchers, and such personnel of an organization to determine whether an unidentified executable file or instruction is malicious, is a benign file or instruction concealing malicious content, or otherwise contains computer-executable instructions which configure computing systems to perform malicious operations to infect, damage, hijack, destabilize, or otherwise harm normal functioning of the computing system. Organizations and enterprises can collect a diverse range of malicious samples, enabling network administrators, cybersecurity researchers, and such personnel of an organization to derive malicious elements which can be matched against unidentified file samples to preventatively detect malicious attacks.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an architectural diagram of a cloud computing system according to examples of the present disclosure.

FIG. 2 illustrates a schematic diagram of a private threat database according to examples of the present disclosure.

FIG. 3 illustrates a diagram of a feature space based learning model according to examples of the present disclosure.

FIG. 4A illustrates a flowchart of a training method according to examples of the present disclosure.

FIG. 4B illustrates a layout of an executable file according to examples of the present disclosure.

FIG. 5 illustrates an example system for implementing the processes and methods described herein for implementing embedding learning models and entropy exclusion of labeled training data.

### DETAILED DESCRIPTION

Different organizations and enterprises will respectively acquire malicious samples which are vastly heterogeneous. Consequently, each individual organization and enterprise may acquire only a limited selection of malicious samples, granting each individual organization and enterprise limited capability of detecting malicious attacks. Organizations and enterprises become capable of detecting more incidences of malicious attacks when in possession of more diverse threat databases, leading to deriving larger sets of executable files and instructions which can potentially match against more unidentified samples.

Therefore, organizations and enterprises seek to exchange and share knowledge of malicious samples, allowing each organization and enterprise to expand its capability for identifying malicious attacks. However, inter-organization and inter-enterprise sharing of data can result in private or secure information being unavoidably exposed. For such reasons, organizations and enterprises wish to acquire attack-identifying capabilities based on files and instructions sampled by other organizations and enterprises even if those samples cannot be shared.

Systems and methods discussed herein are directed to implementing training for learning models, and more specifically training copies of a private adapter network at respective client computing devices; and aggregating of trained adapter weight sets in a common parameter space while training a hosted foundation model at a cloud computing system.

In the routine course of business operations and day-to-day transactions, organizations and enterprises host various computing services for end users, organizational personnel, and other internal and external users on one or more networks. A network can be configured to host various computing infrastructures; computing resources; computer-executable applications; databases; computing platforms for deploying computer-executable applications, databases, and the like; application programming interface (“API”) backends; virtual machines; and any other such computing service accessible by internal and external network connections from one or more client computing devices, external devices, and the like. Networks configured to host one or more of the above computing services can be characterized as private cloud services, such as data centers; public cloud services; and the like. Such networks can include physical hosts and/or virtual hosts, and such hosts can be located in a fashion collocated at premises of one or multiple organizations, distributed over disparate geographical locations, or a combination thereof.

A network can be configured by a network administrator over an infrastructure including network hosts and network devices in communication according to one or more network protocols. Outside the network, any number of client computing devices, external devices, and the like can connect to any host of the network in accordance with a network protocol. One or more networks according to examples of the present disclosure can include wired and wireless local area networks (“LANs”) and such networks supported by IEEE 802 LAN standards. Network protocols according to examples of the present disclosure can include any protocol suitable for delivering data packets through one or more networks, such as, for example, packet-based and/or datagram-based protocols such as Internet Protocol (“IP”), Transmission Control Protocol (“TCP”), User Datagram Protocol (“UDP”), other types of protocols, and/or combinations thereof.

A network administrator can control access to the network by configuring a network domain encompassing computing hosts of the network and network devices of the network. For example, one or more private networks, such as an organizational intranet, can restrict access to client computing devices authenticated by security credentials of an organization, compared to one or more public networks such as the Internet.

Computing hosts of the network can be servers which provide computing resources for hosted frontends, backends, middleware, databases, applications, interfaces, web services, and the like. These computing resources can include, for example, computer-executable applications, databases, platforms, services, virtual machines, and the like. While any of these hosted elements are deployed and running over the network, one or more respective computing hosts where the element is hosted can be described as undergoing uptime. While these hosted elements are not running and/or not available, the network and one or more respective computing hosts where the element is hosted can be described as undergoing downtime.

Routine business operations and transactions of organizations and enterprises can be compromised by one or more computing hosts being configured by malware to execute malicious instructions, which can disrupt or damage computing resources or hosted services; induce downtime in computing resources or hosted services; breach security and/or access controls of one or more networks; allow arbitrary computer-executable instructions to run on one or more computing hosts; and so on.

Network administrators, cybersecurity researchers, and such personnel of an organization will routinely encounter unidentified files introduced to one or more networks of an organization or enterprise, and such unidentified files can be computer-executable files which cause processors of computing hosts of the network to run one or more potentially malicious processes. Any such unidentified file and potentially malicious processes induced by unidentified files could potentially give rise to malware infection.

Security tools can configure computing hosts to perform various measures to prevent malware infections in real time. However, each individual computing host can run dozens or hundreds of processes concurrently and store thousands or millions of unidentified files. As such, the number of potential threats represented by unidentified files across computing hosts of different organizations vastly outstrips the computational resources available to scan and identify such unidentified files. Security tools are therefore centrally configured by a service provider to provide services to computing hosts of many organizations.

Furthermore, security services which provide rapid and adaptive recognition of malware are increasingly important, with the growth of malware which renders recovery of system functionality after infection greatly onerous or impossible. Thus, it is desirable to enable computing systems to recognize discriminating features of malware without human intervention. Machine learning technologies can be deployed to enable computing systems to be trained to recognize discriminating features of malware from samples of known malware and known benign software, and thereby classify previously unseen computer-executable applications as either malware or benign.

Cloud computing systems can be configured to host learning models to provide such security services. Cloud computing systems can be configured to provide collections of servers hosting computing resources, such as security tools, accessible to computing hosts of various organizations. Cloud computing systems further provide distributed computing, parallel computing, improved availability of physical or virtual computing resources, and such benefits. Learning models can be trained to derive parameters and weights which can be stored on storage of the cloud computing system and, upon execution, loaded into memory of the cloud computing system.

A cloud computing system can receive, over one or more networks, data forwarded by various client computing devices for the computation and output of results required for the performance of various computing tasks, such as identifying malware. Client computing devices can connect to the cloud computing system through edge nodes of the cloud computing system. An edge node can be any server providing an outbound connection from connections to other nodes of the cloud computing system, and thus can demarcate a logical edge, and not necessarily a physical edge, of a network of the cloud computing system. Moreover, edge nodes can include edge-based logical nodes that deploy non-centralized computing resources the cloud computing system, such as cloudlets, fog nodes, and the like.

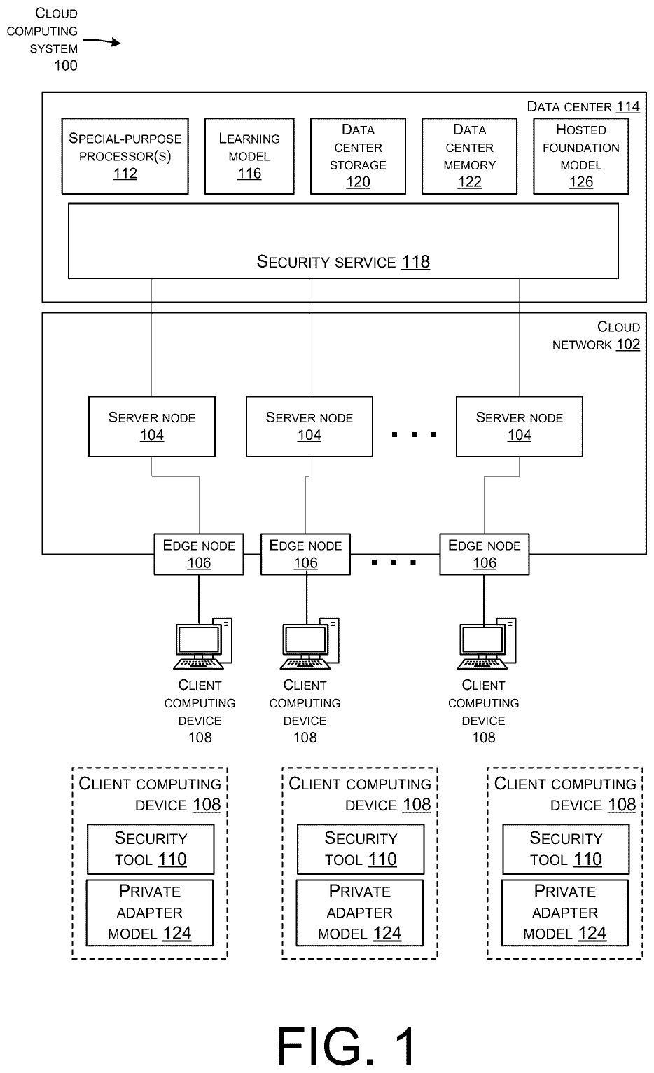

FIG. 1 illustrates an architectural diagram of a cloud computing system 100 according to examples of the present disclosure. The cloud computing system 100 can be implemented over a cloud network 102 of physical or virtual server nodes 104 connected by physical or virtual network connections. Furthermore, the cloud network 102 terminates at physical or virtual edge nodes 106 located at physical and/or logical edges of the cloud network 102. The edge nodes 106 can connect to any number of client computing devices 108. A client computing device 108 can run a respective instance of a security tool 110.

Security tools 110 can be, generally, computer-executable applications which enable, when executed by a client computing device 108, the client computing device 108 to communicate with a security service 118 over the cloud network 102 to access a variety of hosted services provided by the security service 118 to users of a client computing device 108. Users of a client computing device 108 can operate a frontend provided by the respective security tool 110 running on the client computing device 108 so as to access the hosted services of the security service 118 over one or more network connections.

For example, security tools 110 can include various analytics tools for investigating unidentified files of any arbitrary file format arriving at any computing systems and/or networks, system and/or network monitoring tools that monitor computing systems and/or networks for arrivals of unidentified files in real time, incident reporting tools that receive reports of potential intrusions or infection from unidentified files from organizational personnel, and the like, without limitation; different client computing devices 108 can run different such security tools 110 or multiple such security tools. Functions of security tools 110 can include, for example, blocking security holes and security exploits; filtering inbound and outbound connections; policy enforcement; scanning and analysis of data and computer-executable files; and the like. Such functions can be performed at least in part by hosted services providing backend functionality.

Hosted services of a security service 118 can be executed by one or more physical or virtual processors of the cloud computing system 100 in response to operations performed by, or operations performed by an end user through, any of the client computing devices 108 configured by a running security tool 110, by the exchange of data and communication between the client computing devices 108 and the security service 118 over the cloud network 102.

Hosted services of a security service 118 can include one or more learning models. A learning model can be implemented on special-purpose processors 112, which can be hosted at a data center 114. The data center 114 can be part of the cloud network 102 or in communication with the cloud network 102 by network connections. Special-purpose processors 112 can be computing devices having hardware or software elements facilitating computation of neural network computing tasks such as training and inference computations. For example, special-purpose processors 112 can be accelerators, such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate computation of tasks such as training and inference, special-purpose processors 112 can, for example, implement engines operative to compute mathematical operations such as matrix operations and vector operations.

According to example embodiments of the present disclosure, client computing devices 108 may have comparatively limited local storage and memory, as well as limited data bus throughput, compared to cloud computing systems and thus cannot practically load the entirety of models and weight sets into local storage and memory.

Thus, a learning model 116 can be stored on physical or virtual storage of the data center 114 (“data center storage 120”), and can be loaded into physical or virtual memory of the data center 114 (“data center memory 122”) (which can be dedicated memory of the special-purpose processors 112) alongside trained weight sets, configuring the special-purpose processors 112 to execute the learning model 116 to compute input related to one or more tasks. The input can be obtained from one or more client computing devices 108 over a network connection from a client computing device 108.

Execution of the learning model 116 can then cause the data center 114 to load the learning model 116 into data center memory 122 and compute results. The learning model 116 can output results required for the performance of heterogeneous functions of the security service 118. The security service 118 hosted on the cloud computing system 100 can provide centralized computing for any number of security tools 110 by acting upon results output by the learning model 116 and communicate over the cloud network 102 to cause the client computing devices 108, configured by a security tool 110, to act upon instructions derived from the results output by the learning model 116.

After potentially malicious processes have run and unidentified files have been collected as samples, network administrators, cybersecurity researchers, and such personnel can store samples of potentially malicious computer-executable files in records of a database (subsequently, a “threat database”). Samples stored in threat databases can be referenced by hosted services of a security service 118 to configure perform scanning, analysis, training of learning models, and the like. Novel malware can, at any time, arise at computing hosts of an organization before a service provider has configured security tools to detect instances of such novel malware. While security tools can configure computing hosts to scan unidentified files so as to identify matches against identified malicious samples, due to the unpredictable, ad-hoc, and idiosyncratic natures of malware infections, there is often insufficient time for a computing host to conclusively identify the file by matching against identified malicious samples. When files are scanned in real time, computing hosts are configured to scan incomplete object code, and therefore cannot necessarily identify filenames, file formats, nature of the computer-executable instructions encoded in the object code, and the like.

Consequently, learning models can configure computing systems to, based on features of at least partial object code of an unidentified executable file or instruction, classify the unidentified file or instruction as a malicious file or instruction or as a benign file or instruction concealing malicious content; as a benign file or instruction; as a potentially malicious file or instruction requiring quarantine for further analysis; and the like. Alternatively, learning models can configure computing systems to, based on features of at least partial object code of an unidentified file, or features of an unidentified instruction, place the unidentified file or instruction in a feature space and assign the unidentified file to one or more clusters of data points representing other identified files or instruction, so as to characterize the unidentified file or instruction by labels of one or more of these clusters. Alternatively, learning models can configure computing systems to, based on features of at least partial object code of an unidentified file, or based on features of an unidentified instruction, determine whether the unidentified file or instruction is a statistical outlier, a statistical anomaly, and the like among a dataset including statistically normal data points and statistical outlier or statistically anomalous data points.

Consequently, organizations and enterprises can, by extracting features from one or more sample datasets (which can include data points labeled as malicious, as benign, and the like), configure a computing host to train a learning model (which can be a classification learning model, a clustering learning model, an anomaly detection learning model, and the like) to embed feature vectors in a feature space. Regardless of the nature of a learning model, the computing host should be configured to embed feature vectors in a feature space so as to magnify distances between at least some data points labeled as malicious and at least some data points labeled as benign.

A learning model, according to examples of the present disclosure, can include a set of computer-readable instructions executable by one or more processors of a computing system to perform tasks that include processing input having various parameters and outputting results. A learning model can be, for example, a layered model such as a deep neural network, which can have a fully-connected structure, can have a feedforward structure such as a convolutional neural network (“CNN”), can have a backpropagation structure such as a recurrent neural network (“RNN”), can be structured based on multi-head attention, such as bidirectional encoder representations from transformers (“BERT”) or generative pretrained transformer (“GPT”), or can have other architectures suited to the computation of particular tasks. Tasks can include, for example, classification, clustering, anomaly detection, matching, regression, and the like.

A computing host performing tasks such as classification, clustering, anomaly detection, and the like, with regard to examples of the present disclosure, can ultimately determine whether an unidentified file or instruction, represented as a data point in a feature space, is closer to data points labeled as malicious, data points labeled as benign, or data points otherwise labeled. Thereby, a computing host can be configured to classify the unidentified file or instruction according to one of several labels; characterize the unidentified file or instruction by labels of one or more clusters; characterize the unidentified file or instruction as statistically normal or a statistical outlier or statistically anomalous; and the like.

For the purpose of examples of the present disclosure, one or more methods and/or systems can cause a computing host to output at least a feature space. A feature space can include a description of an n-dimensional vector space, and include one or more mappings by which vectors in real vector space R″ can be mapped to the n-dimensional vector space. By methods and systems according to examples of the present disclosure, a computing host can further output classifications of unlabeled executable files or instructions, clusterings of unlabeled executable files or instructions, determinations of unlabeled executable files or instructions as outliers or anomalous, and the like, to distinguish malicious files or instructions from benign files or instructions.

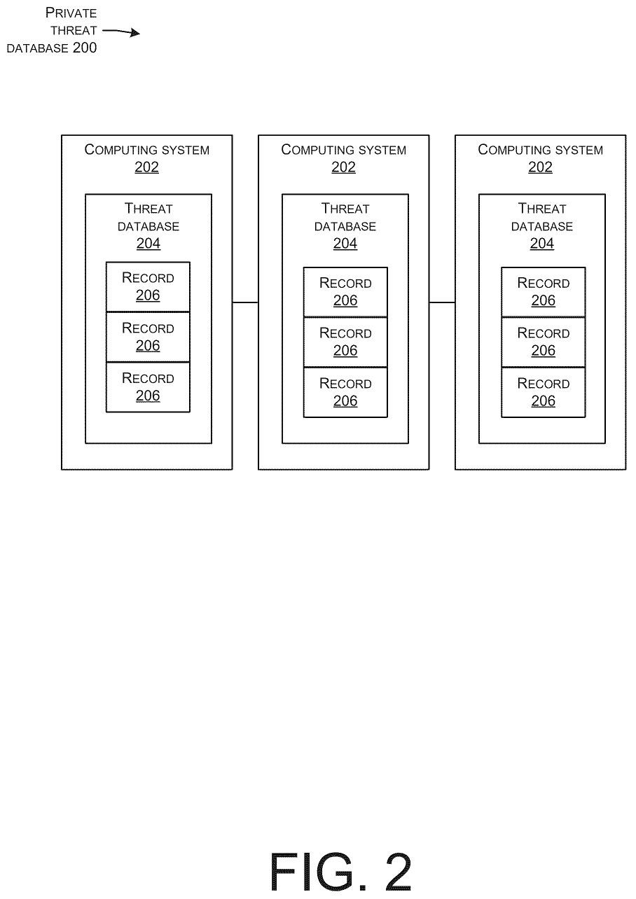

FIG. 2 illustrates a schematic diagram of a private threat database 200 according to examples of the present disclosure. Computing systems 202 can include any networked computing systems, which can individually or collectively store a threat database 204 accessible by some number of other computing systems over a private network, by running a data processing platform.

A data processing platform can be one or more applications running on a computing system and/or one or more services hosted on a network provided for a database. A data processing platform according to the present disclosure can refer to one or more such platforms, each capable of performing functionalities referenced to in the context of the disclosure. The database can be stored on a computer or private web server, distributed across multiple physically privately networked computers or web servers, distributed across computers or networks over a physical or virtual cluster, or otherwise stored by other computing architectures providing storage as known by persons skilled in the art.

The data records of the threat database 204 can be stored and updated across the networked computing systems 202 in an architecturally centralized or decentralized, single-copy or distributed, strongly consistent or weakly consistent, duplicated or replicated fashion, and may generally be stored according to any suitable database architecture known to persons skilled in the art.

According to examples of the present disclosure, a threat database can include records 206, each record 206 including a computer-readable representation of object code of a computer-executable file as described above, as well as any number of fields which identify the computer-executable file as malware and provide additional identifying and contextual information regarding the malware, such as filenames, dates and times when malware instances were identified, pathways by which the malware infects computing systems, and the like. Malware can include any samples of executable files which are executable by computing systems to perform particular malicious operations to infect, damage, hijack, destabilize, or otherwise harm normal functioning of the computing system by a similar pathway.

As described above, an executable file may include, for example, object code compiled to the PE format, object code compiled to the Mach-O format, object code compiled to ELF, and the like. The object code may be further statically or dynamically linked to additional object code and/or libraries. Additionally, an executable file may include some number of headers, such as one or more executable file format-defining headers. Additionally, executable file formats may define one or more import tables. Additionally, executable file formats may include resource sections.

A record 206 of a threat database can alternatively or additionally include a computer-readable representation of one or more computer-executable instructions (such as writing to volatile memory, launching executable files, or flow of network traffic to remote network addresses), which can be launched by a command-line instruction, or loaded from a script stored on non-volatile memory, an unsigned executable file stored on non-volatile memory, a dynamically linked library stored on non-volatile memory, and the like.

Data stored in a threat database 204 as described above can be computed by a client computing device 108 configured by learning models and weight sets. According to example embodiments of the present disclosure, client computing devices 108 have some degree of computational power, local storage and memory with which to perform such computation.

Client computing devices 108 can be geographically isolated from the computational resources of the cloud computing system 100, and can also be logically isolated from the cloud computing system. Thus, logically, data stored at a threat database 204 on a client computing device 108 can be separated from the cloud computing system 100 by one or more data planes, such as data planes defining one or more networks which convey data between the client computing device 108 and the cloud computing system 100.

To some extent, security tools 110 can configure client computing devices 108 to perform computing tasks such as scanning and analysis of data, computer-executable files, and computer-executable instructions, and training of learning models, as described above. However, the relatively lower computing resource specifications of client computing devices 108 compared to a cloud computing system 100, including processing power, storage, and memory, results in a relative disparity in computational capacity therebetween. Thus, learning models which are components of a security service 118, running on client computing devices 108, may not be trained using local computing resources, and may be trained instead at higher-powered computing systems such as cloud computing systems 100.

For such training purposes, it is not preferred for data to be delivered from client computing devices 108 to one or more remote computing hosts over one or more networks through interfaces hosted at edge nodes 106. Records 206 stored in a threat database 204 as described above can be privacy-sensitive for an organization or enterprise operating the computing hosts 202 hosting the threat database 204. Since malware can be designed to steal or compromise private or secure data of an organization or enterprise, malicious samples collected by an organization or enterprise may have been identified because such samples are executable files or executable instructions which have already executed on computing hosts of the organization or enterprise, and have stored or copied private or secure data. Furthermore, since malware can be designed to circumvent security configurations specific to computing and network system architecture of an organization or enterprise, malware samples can expose private or secure aspects of security configurations.

Consequently, organizations and enterprises risk exposing private or secure data in the course of delivering records 206 stored in a threat database 204 to remote computing hosts for training of learning models which are components of a security service 118. Therefore, example embodiments of the present disclosure provide staggered training of a learning model by two phases: protected training at client computing devices 108, and aggregated training at a remote computing host. To implement staggered training, a private adapter model is adapted to a foundation weight set of a hosted foundation model. Any number of copies of the private adapter model can be distributed across any number of client computing devices. Example embodiments of the present disclosure provide training copies of the private adapter network at respective client computing devices; and aggregating of trained adapter weight sets in a common parameter space while training a hosted foundation model.

Example embodiments of the present invention provide adaptation of a private adapter model to a foundation weight set of a hosted foundation model. Herein, a hosted foundation model should be understood as referring to a learning model making up at least part of a security service 118 as described with reference to FIG. 1, hosted on computing hosts of a cloud computing system 100 for access over one or more network connections by client computing devices 108. Furthermore, a private adapter model should be understood as referring to a learning model, stored locally on a client computing device, which configures a client computing device to perform a protected update, during training, on an adapter weight set in a parameter space of reduced dimensionality relative to a foundation weight set of the hosted foundation model.

The private adapter model and the adapter weight set are protected from outbound network connections of client computing devices 108, or at least from outbound network connections to a cloud network 102 hosting a hosted foundation model. By way of example, a client computing device 108 can be configured according to a network policy, such as a firewall, which prevents outbound traffic over network connections while the private adapter model is trained or the adapter weight set is updated. Alternatively and/or additionally, a client computing device 108 can be configured according to a network policy, such as a firewall, to prevent outbound traffic over a network connection to a cloud network 102 hosting a hosted foundation model while permitting inbound traffic. Alternatively and/or additionally, a client computing device 108 can be configured to encrypt the private adapter model and the adapter weight set while a network connection with a cloud network 102 hosting a hosted foundation model is up.

Therefore, a private adapter model can be a subdivision of a hosted foundation model, segmented from some number of layers of a hosted foundation model, such that outputs of one or more layers of the private adapter model can be inputs of one or more layers of the hosted foundation model. Alternatively, a private adapter model can be distinct from the hosted foundation model, without limitation to including layers of the hosted foundation model, and without limitation as to whether outputs of the private adapter model can be inputs of the hosted foundation model or not, given that the private adapter model configures a computing host to perform a protected update on an adapter weight set in a parameter space of reduced dimensionality relative to a foundation weight set of the hosted foundation model.

Updating the adapter weight set in a parameter space of reduced dimensionality relative to a foundation weight set of the hosted foundation model reduces computational resources required by the computing host relative to the cloud computing system. Layers of the hosted foundation model and the private adapter model include respective coefficient matrices. Rows and columns of a coefficient matrix define a vector space having a dimensionality, referred to as rank of the matrix; a parameter space is a common vector space occupied by parameters of one or more weight sets of learning models. According to example embodiments of the present disclosure, a layer of the private adapter model includes a rank-deficient coefficient matrix, having fewer rows or fewer columns than rank of the matrix. Because such a coefficient matrix does not occupy the largest parameter space possible for a matrix of its dimensions, updates to such adapter weight sets are performed in a parameter space of reduced dimensionality relative to a foundation weight set of the hosted foundation model, which occupies a larger parameter space.

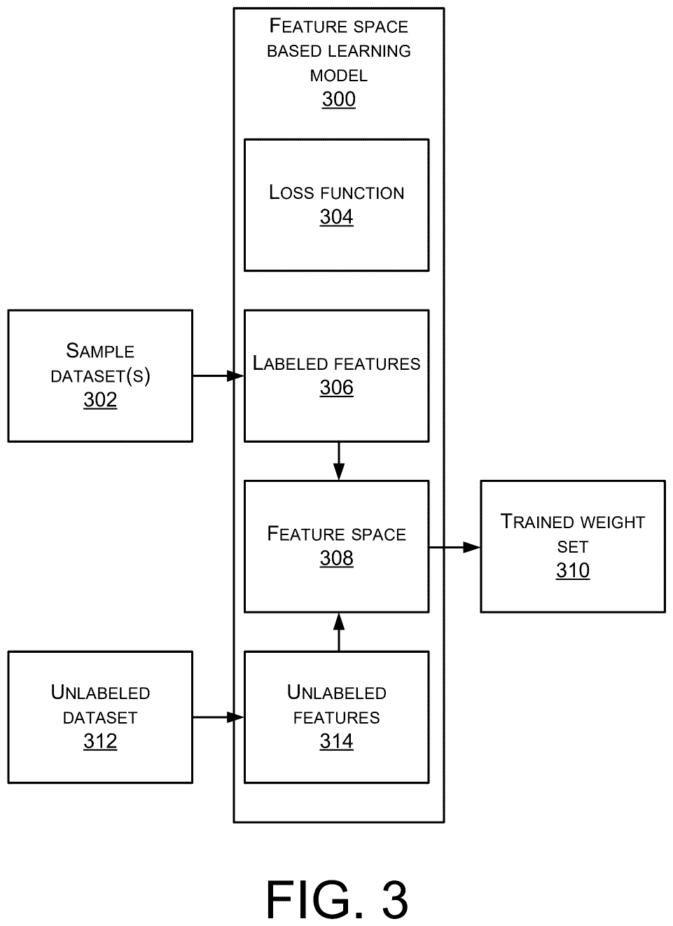

FIG. 1 further illustrates an architectural diagram of storage of a private adapter model in conjunction with hosting of a hosted foundation model. Respective private adapter models 124 are stored on client computing devices 108, and a hosted foundation model 126 is hosted on a cloud computing system 100 of the cloud network 102. A client computing device 108 storing a private adapter model 124 is configured as a learning system as described subsequently with reference to FIG. 3. A cloud computing system 100 hosting a hosted foundation model 126 is, likewise, configured as a learning system as described subsequently with reference to FIG. 3.

Examples of a hosted foundation model and a private adapter model according to example embodiments of the present disclosure include feature space based learning models, as shall be subsequently described in further detail.

FIG. 3 illustrates a diagram of a feature space based learning model 300 according to examples of the present disclosure. It should be understood that a “feature space based learning model” according to examples of the present disclosure can be any of a classification learning model, a clustering learning model, an anomaly detection learning model, and such learning models which configure a computing system to perform tasks determining whether an unidentified file, represented as a data point in a feature space, is closer to data points labeled as malware, data points labeled as benign files, or data points otherwise labeled. Thus, such a learning model can receive, as input, at least data points and a feature space, and can place the data points into the feature space.

The feature space based learning model 300 can be stored on any computing system as described above, and can be hosted on a cloud computing system, as well as stored on any other computing system having one or more physical or virtual processors capable of executing the learning model to compute tasks for particular functions. For the purpose of examples of the present disclosure, such a computing system storing or hosting the feature space based learning model 300 can be referred to as a “learning system.”

The learning system can train the feature space based learning model 300 by loading the feature space based learning model 300 and one or more sample datasets 302 into memory and inputting the one or more sample datasets 302 into the feature space based learning model 300. Training of the feature space based learning model 300 can further be performed on a loss function 304, wherein the feature space based learning model 300 extracts labeled features 306 from the sample datasets 302 and embeds the labeled features 306 on a feature space 308 to optimize the loss function 304. Based thereon, the feature space based learning model 300 can generate and update weight sets on the feature space 308 after each epoch of training. After any number of epochs of training in this manner, a trained weight set 310 can be output. The feature space based learning model 300 can subsequently compute tasks such as classification, clustering, outlier or anomaly detection, or other such tasks upon any number of unlabeled datasets 312, extracting unlabeled features 314 from each unlabeled dataset 312 and embedding the unlabeled features 314 in the feature space 308 to optimize an output of the loss function 304, with reference to the trained weight set 310.

The learning system can load the feature space 308 and the trained weight set 310 into memory and execute the feature space based learning model 300 to compute outputs for a classification task, clustering task, outlier or anomaly detection task, or other such tasks to be performed upon unlabeled datasets 312 stored at a data center storage 120 or stored at a client computing device 108.

By way of example, the feature space based learning model 300 can configure the learning system to predict similarity of unidentified files or instructions to a reference file or instruction, and/or to classify an unidentified file or instruction as clean, malicious, adware, malware, or as any other classification. For instance, the feature space based learning model 300 can configure a learning system to compare a generated hash representing an unidentified sample executable file or executable instruction to a previously generated reference hash value stored in a database from an identified sample executable file or executable instruction. The feature space based learning model 300 can configure a learning system to embed feature vectors extracted from the generated hash into a feature space to derive a first embedded vector (in the form of a matrix, an array, and the like); derive a second embedded vector from embedding feature vectors extracted from the reference hash value into the same feature space; and computing a dot product between the first embedded vector and the second embedded vector, resulting in a similarity score which can range between zero and one, where a larger similarity score represents greater similarity between the files.

The learning system can be configured to refer to a similarity threshold to determine whether the calculated similarity score indicates that the unidentified sample executable file or executable instruction is similar to the identified sample executable file or executable instruction. In example implementations, the learning system can be configured to classify, cluster, or detect as anomalous the unidentified sample executable file or executable instruction using other techniques, such as, for example, calculating an average difference between a first embedded vector and a second embedded vector or by comparing statistical measures calculated over the first embedded vector to reference statistical measures calculated over the second embedded vector.

For example, with regard to tasks relating to the function of classification, commonly available learning models include BERT or GPT.

The hosted foundation model 126 is, as described above, a hosted service of a security service 118, and can be executed in response to operations performed by, or operations performed by an end user through, any of the client computing devices 108 configured by a running security tool 110. In contrast, a private adapter model 124 stored on a client computing device 108 is not a hosted service, and cannot be executed or otherwise accessed by any other client computing device 108 or the cloud computing system 100.

Thus, a cloud computing system 100 can train the hosted foundation model 126 by loading the hosted foundation model 126 and one or more sample datasets into memory and inputting the one or more sample datasets into the hosted foundation model 126. Furthermore, a client computing device 108 can train the private adapter model 124 by loading the private adapter model 124 and one or more sample datasets into memory and inputting the one or more sample datasets into the private adapter model 124.

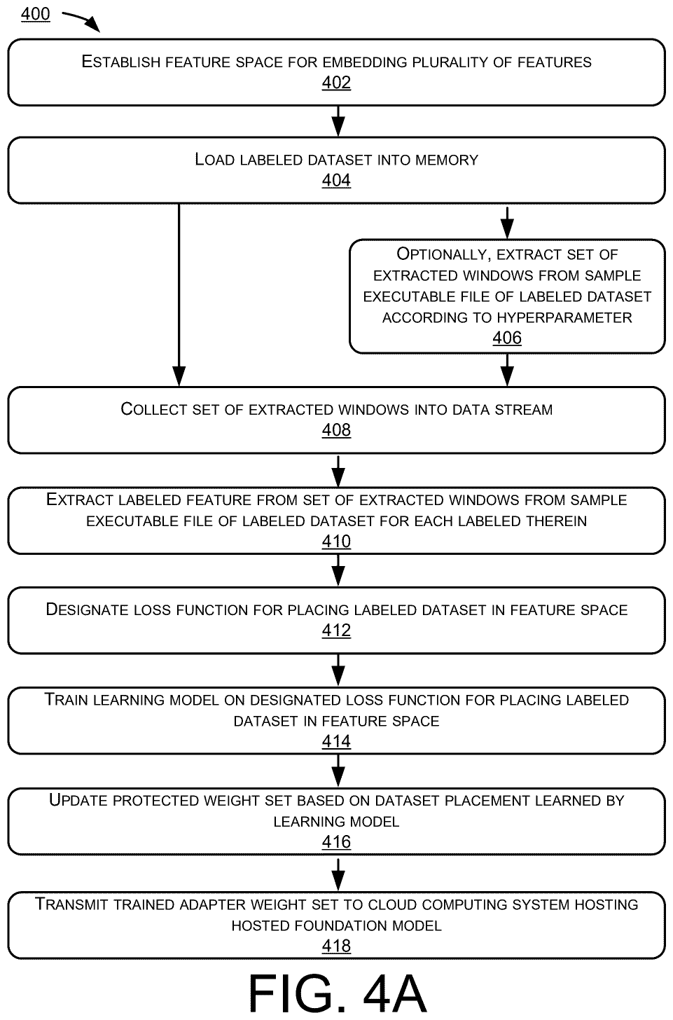

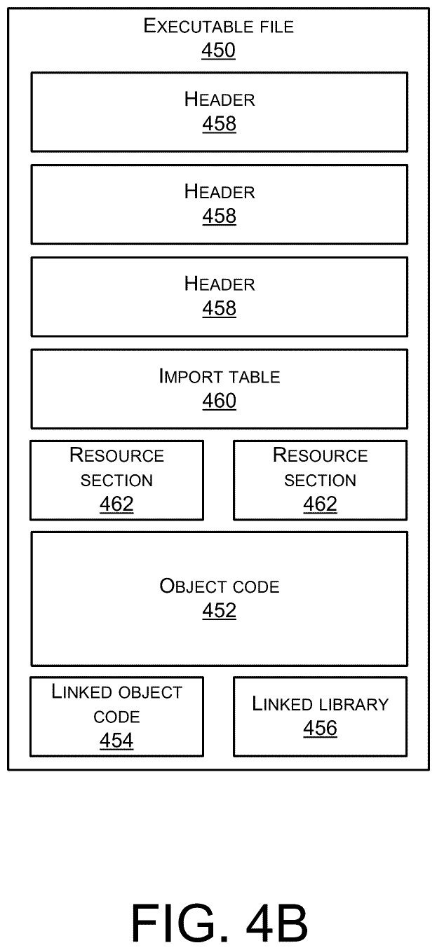

Training the hosted foundation model 126 and training the private adapter model 124 can proceed as subsequently described with reference to FIG. 4A.

FIG. 4A illustrates a flowchart of a training method 400 according to examples of the present disclosure. Each step of the training method 400 can be performed by one or more processors of a learning system, such as physical or virtual processors of a cloud computing system or a client computing device as described above with reference to FIG. 1.

In step 402 of the training method 400, one or more processors of a learning system establish a feature space for embedding a plurality of features.

Feature embedding generally refers to translating features of a dataset into a dimensional space of reduced dimensionality so as to increase, or maximize, distances between data points (such as features from sample datasets as described above) which need to be distinguished in computing a task for a particular function, and decrease, or minimize, distances between data points to be classified, clustered, or otherwise found similar or dissimilar in computing a task for a particular function. For example, functions for expressing distance between two data points can be any function which expresses Euclidean distance, such as L2-norm; Manhattan distance; any function which expresses cosine distance, such as the negative of cosine similarity; any function which expresses information distance, such as Hamming distance; or any other suitable distance function as known to persons skilled in the art. According to examples of the present disclosure, a distance function evaluating two data points x and y can be written as D(x, y).

According to examples of the present disclosure, datasets can be composed of instances of executable files. FIG. 4B illustrates a layout of an executable file 450 according to examples of the present disclosure. An executable file 450 can include, for example, object code 452 compiled to the Portable Executable (“PE”) format executable on computing systems running, for example, Windows operating systems from Microsoft Corporation of Redmond, Washington; object code compiled to the Mach object (“Mach-O”) format executable on computing systems running, for example, MacOS or iOS operating systems from Apple Inc. of Cupertino, California; object code compiled to the Executable and Linkable Format (“ELF”) executable on computing systems running, for example, open-source Linux operating systems or Android operating systems; and the like.

The object code 452 can be further statically or dynamically linked to additional object code 454 and/or libraries 456, which can contain functions, routines, objects, variables, and other source code which can be called in source code, the calls being resolved by a compiler during compilation of the source code to create linked object code which can be executed by a computer as part of the executable file 450.

Additionally, an executable file 450 can include some number of headers 458 which occupy sequences of bytes preceding compiled object code 452 and/or linked object code 454 and/or linked libraries 456; following compiled object code 452 and/or linked object code 454 and/or linked libraries 456; and/or interleaved between compiled object code 452 and/or linked object code 454 and/or linked libraries 456. Executable file formats can define different types of headers 458, as well as sub-headers thereof, containing various sequences of data which can be referenced by object code 452, can be referenced during execution of the executable file 450 at runtime, and so on.

For example, executable file formats can define one or more executable file format-defining headers. Generally, different formats of executable files can define different headers whose inclusion in an executable file define that file as belonging to that respective format. For example, executable files of the PE format can define a Disk Operating System (“DOS”) executable header, a PE header, as well as an optional header (it should be understood that optional headers are called “optional” by naming conventions, and are not necessarily optional for the purpose of understanding examples of the present disclosure). Executable files of the Mach-O format can define a Mach-O header. ELF executable files can define an ELF header.

Additionally, executable file formats can define one or more import tables 460. An import table 460 can resolve references in the object code which link one or more libraries providing functions, routines, objects, variables, and other source code which can be linked to the executable file during compilation or at runtime.

Additionally, executable file formats can include resource sections 462. For example, executable files of the PE Format can include file icon images, image files in general, dialog boxes, and the like. These resources can be stored in one or more discrete sections of the executable file 450.

Formatting of particular types of headers and contents of particular types of headers need not be further detailed for understanding of the present disclosure.

It should be understood that, while object code 452 of an executable file 450 is generated by source code compilers in a computer-executable format, the object code 452 can also be represented in a computer-readable but non-computer-executable format, including as a sequence of ASCII values, and as a sequence of hexadecimal values. Object code 452 of an executable file 450, represented as ASCII values and/or hexadecimal values rather than represented in binary form, can be read by a computing system while being in a non-computer-executable representation.

For example, a computer-readable representation of any given file, including one or more executable files can generally be described as a binary large object (“BLOB”). A BLOB is generally any arbitrarily large data file which can include a computer-readable representation of any arbitrary file format, including representations of object code and other contents of executable files. It should be understood that, although a “BLOB” does not necessarily follow any standard implementation, a BLOB according to examples of the present disclosure should at least represent object code of an executable file in a non-computer-executable format, such as in the form of a sequence of ASCII values or as a sequence of hexadecimal values rather than binary form, as mentioned above.

For brevity, any such non-computer-executable representation, however stored on a computing system, shall be referred to herein as a “sample.”

Furthermore, according to example embodiments of the present disclosure, datasets can be composed of instances of executable instructions. Instances of executable instructions can include one or more parts of, or the entirety of, a command-line instruction, a script, a dynamically linked library, and the like.

In step 404 of the training method 400, one or more processors of the learning system load a labeled dataset into memory.

Datasets can include labeled malicious samples, labeled benign samples, and any combination thereof. A dataset can include at least samples of executable files and/or instructions labeled as malicious. For the purpose of examples of the present disclosure, malicious files and instructions should be understood as encompassing known executable files and instructions which are executable by computing systems to perform particular malicious operations to infect, damage, hijack, destabilize, or otherwise harm normal functioning of the computing system by various pathways. Benign files and instructions should be understood as any executable files and instructions which do not yield such outcomes when executed by computing systems.

Features of sample executable files and instructions can be statically or dynamically detectable features. Statically detectable features can be features of the executable files or instructions which are present outside of runtime, such as a string of text present in the executable files or instructions, a checksum of part of all of the source code such as an MD5 hash, and such features as known to exist in executable files and/or instructions outside of runtime. Dynamically detectable features can be operations performed by a computing system executing the executable file or instruction during runtime, such as read or write accesses to particular memory addresses, read or write accesses of memory blocks of particular sizes, read or write accesses to particular files on non-volatile storage, and the like.

A feature space based learning model according to examples of the present disclosure can be trained to place a labeled dataset representing malicious files and/or instructions, benign files and/or instructions, and any combination thereof, into a feature space. The labeled dataset can include samples of executable files and/or instructions, each sample being labeled as having one or more of multiple distinct features. Any number of these features, alone or in combination, can distinguish executable files labeled as one kind of malware from executable files labeled as another kind of malware; distinguish executable files labeled as any kind of malware from executable files labeled as benign files; distinguish executable files or instructions of one cluster from executable files or instructions of another cluster, whether one or both clusters contain executable files or instructions labeled as malicious; distinguish executable files belonging to one malware family from executable files belonging to all other malware families; distinguish statistically normal executable files or instructions from statistical outlier or statistically anomalous executable files or instructions; and the like.

According to other examples of the present disclosure, one or more processors of a learning system can optionally load at least one labeled dataset and at least one labeled benign dataset into memory, separate from each other. It should be understood that a labeled benign dataset may merely be labeled as benign for distinction from labeled malicious samples in general, and that, moreover, for the purpose of examples of the present disclosure, with regard to sample executable files or instructions labeled as benign, no particular features thereof need be labeled, as there are not necessarily commonalities among benign samples which can be distinguished from malicious features.

Moreover, though a labeled benign dataset may be used for purposes of examples of the present disclosure, it may, or may not, be used alongside a labeled malicious dataset.

In step 406 of the training method 400, optionally, one or more processors of the learning system extract a set of extracted windows from a sample executable file or instruction of the labeled dataset according to a hyperparameter.

Distinct from parameters, processors of a computing system do not learn a hyperparameter while training a learning model. Instead, processors of a computing system configured to run a machine learning model can determine a hyperparameter outside of training the learning model. In this manner, a hyperparameter can reflect intrinsic characteristics of the learning model which will not be learned, or which will determine performance of the processors of the computing system during the learning process.

Thus, optimizing a loss function can refer to the process of training the machine learning model, while optimizing a hyperparameter can refer to the process of determining a hyperparameter before training the machine learning model. One or more processors of the computing system can determine hyperparameters by an additional optimization computation.

According to examples of the present disclosure, hyperparameters can define at least a window size and a window distance (which can each be specified in bits or in bytes), and one or more processors of the learning system can extract sub-sequences of bits from a sample of the labeled dataset, each sub-sequence having a length corresponding to the window size hyperparameter, and sub-sequences being spaced apart according to the window distance hyperparameter.

By way of example, a window size hyperparameter can have a value of 256 bytes, 1028 bytes, 1 megabyte, or otherwise some multiple of 8 bytes. A window distance hyperparameter can likewise have a value of some multiple of 8 bytes, such as 1028 bytes.

Based on the window size hyperparameter and the window distance hyperparameter, one or more processors of the learning system can extract some or all possible sub-sequence of bytes from a same sample of the labeled subset: i.e., the one or more processors can traverse a sample executable file or instruction of the labeled subset, and extract, along a sequence of bytes making up the sample, some sub-sequences or substantially all sub-sequences having a length corresponding to the window size hyperparameter, and spaced apart according to the window distance hyperparameter. Thus, these sub-sequences do not overlap.

Subsequently, the set of windows extracted from a same sample of the labeled dataset can be referred to herein as a “set of extracted windows,” for short. Different sets of extracted windows can be taken from different samples of the labeled dataset.

In step 408 of the training method 400, one or more processors of the learning system collects the set of extracted windows into a data stream.

It should be understood that a data stream can be implemented according to various data structures which can store a sequence of bytes, where one or more processors of the learning system can be configured to read the various data structures so as to sequentially access ASCII values or hexadecimal values contained in the sequence of bytes. For example, a data stream can be implemented in one or more buffer data structures in which a sequence of bytes can be stored.

Thus, one or more processors of the computing system can store the set of extracted windows in one or more data structures making up the data stream, so that the one or more processors can then sequentially access the ASCII values or hexadecimal values stored in the data stream.

It should be understood that the set of extracted windows can be stored in the data stream in their order of extraction from a sample executable file or instruction, or stored in any arbitrary order.

A data stream can contain a set of extracted windows from a sample executable file or instruction, which, as described above, can have one or more labels.

In step 410 of the training method 400, one or more processors of the learning system extract a labeled feature from a set of extracted windows from a sample executable file, pr instruction, of the labeled dataset for each label therein.

According to examples of the present disclosure, a feature extracted from a set of extracted windows can be a sequence of bytes extracted from a header of the sample executable file or a sub-header of the sample executable file. A header or sub-header of the sample executable file can be, for example, an executable file format-defining header, such as a DOS executable header, a PE header, or an optional header.

According to examples of the present disclosure, a feature extracted from a set of extracted windows can be a sequence of bytes extracted from executable sections of object code. A feature can include, for example, some number of consecutive bytes of an executable section of the object code. A feature can be extracted from a first executable section of object code, or from a last executable section thereof, or from any n-th executable section thereof.

According to examples of the present disclosure, a feature extracted from a set of extracted windows can be a sequence of bytes extracted from resource sections of executable files. A feature can include, for example, some number of bytes of any resource of a resource section of the executable file. A feature can be extracted from a first resource of a resource section, or from a last resource of the resource section, or from any n-th resource of the resource section.

According to examples of the present disclosure, a feature extracted from a set of extracted windows can be a sequence of bytes extracted from an import table. A feature can include, for example, some number of bytes of any one or more strings of an import table.

According to examples of the present disclosure, a feature extracted from a set of extracted windows can be one or more sequences of bytes including any combination of the above examples.

According to examples of the present disclosure, one or more sequences of bytes as described above can be taken from a data stream storing a set of extracted windows from a sample executable file or instruction (rather than from the original sample executable file or instruction) by taking any number of n-grams (i.e., arbitrarily taking contiguous sequences of n bytes from a sequence of longer than n bytes, without regard as to the content of the n-gram or the content of the longer sequence) from sequentially accessed bytes of the data stream.

In step 412 of the training method 400, one or more processors of the learning system designates a loss function for placing the labeled dataset in the feature space.

A loss function, which can be more generally an objective function or a component of an objective function, is generally any mathematical function having an output which can be optimized during the training of a learning model.

One or more processors of the learning system can be configured to perform training of the learning model, at least in part, on at least the designated loss function to learn a placement of the labeled dataset in the feature space. One or more processors of the learning system can be configured to learn the designated loss function by iteratively tuning parameters of the loss function over epochs of the training process. For example, the loss function can be any function having one distance or more than one distance as parameters, where one or more parameters of the loss function can be optimized, simultaneously, in alternation, or in any other fashion over iterations, for minimal values of at least distance and/or maximal values of at least one distance.

In step 414 of the training method 400, one or more processors of the learning system train the learning model on the designated loss function for placing the labeled dataset in the feature space.

For the purpose of such training, samples of the labeled dataset can be divided into multiple batches, where samples of each batch can be randomly selected from the labeled dataset, without replacement. Each batch can be equal in size. Thus, each batch is expected, statistically, to contain approximately similar numbers of samples of each labeled feature on average.

According to examples of the present disclosure, batch sizes can be set so as to increase probability that each batch includes at least one positive data point for each labeled feature and at least one negative data point for each labeled feature. Thus, batch sizes should not be so small that these requirements are not met.

In step 416 of the training method 400, one or more processors of the learning system performs a protected update on an adapter weight set based on a dataset placement learned by the learning model.

A weight set can include various parameters which determine the operation of the learning model in placing the labeled dataset in the feature space. The training as performed in the above-mentioned training phases can be reflected in updates to the weight set. The weight set can be updated according to gradient descent (“GD”) (that is, updated after computation completes for an epoch), stochastic gradient descent (“SGD”), mini-batch stochastic gradient descent (“MB-SGD”) (that is, updated after computation of each batch), backpropagation (“BP”), or any suitable other manner of updating weight sets as known to persons skilled in the art. Each of these weight set update operations can take one or more sets of previous coefficient values of the same weight set as an input.

Furthermore, according to example embodiments of the present disclosure, where the learning model is a private adapter model 124 and the learning system is a client computing device 108, updating the adapter weight set is performed as a protected update. During each epoch of the training, protected update of an adapter weight set can be performed by protecting an adapter weight set at a first layer of the private adapter model. Protecting an adapter weight set can be performed by applying an operation upon coefficients of the adapter weight set to transform or alter coefficient values, before those coefficient values are input to a weight set update operation. By way of example, an operation can be a noise injection operation.

Thus, by performing a protected update to an adapter weight set, true values of the coefficients of the adapter weight set derived from inputting features of a labeled dataset at a first layer of the private adapter model are obfuscated. Therefore, features of the labeled dataset are obfuscated through each subsequent epochs of training the private adapter model, such that privacy-sensitive elements of records stored in a threat database are not exposed through the training method 400.

In step 418 of the training method 400, one or more processors of the learning system transmit a trained adapter weight set to a cloud computing system hosting a hosted foundation model.

After a private adapter model 124 is trained for a number of epochs according to the training method 400, a trained adapter weight set as updated following the latest epoch is transmitted to edge nodes 106 of a cloud computing system 100 over one or more network connections. Following multiple rounds of protected updates of adapter weight sets across multiple epochs, the trained adapter weight set can now be exposed over public or private network connections without exposing privacy-sensitive elements of records stored in a threat database.

Edge nodes 106 can respectively receive trained adapter weight sets and, by forwarding to additional server nodes 104, collect each trained adapter weight set at the data center 114. The hosted foundation model 126 then configures computing resources of the data center 114 to train the hosted foundation model 126 according to the training method 400 above, where a labeled dataset is taken from a hosted threat database stored on the data center storage 120, and not from a private threat database 200. Furthermore, according to the training method 400, trained adapter weight sets are updated at step 416. As configured by the hosted foundation model 126, the updates of step 416 need not be protected.

Furthermore, a final layer of the hosted foundation model configures computing resources of the data center 114 to aggregate, in a common parameter space, any number of trained adapter weight sets of any number of copies of the private adapter model, updated after respective training. Aggregation can be performed by configuring computing resources of the data center to perform an order-invariant aggregation function. By way of example, without limitation thereto, adapter weight sets of any number of copies of the private adapter model can be aggregated by a sum function, an average function, a weighted sum function, a weighted average function, and the like.

While the adapter weight sets occupy parameter spaces of reduced dimensionality relative to a foundation weight set of the hosted foundation model, where each such parameter space of reduced dimensionality can be a different parameter space, the aggregated adapter weight sets now occupy a common parameter space, which can have dimensionality less than or the same as the foundation weight set of the hosted foundation model.

Subsequently, the aggregated trained weight set can be a hosted service of the security service 118, such that users of a client computing device 108 can operate a frontend provided by the respective security tool 110 running on the client computing device 108 so as to access a hosted foundation model 126 having the aggregated trained weight set over one or more network connections.

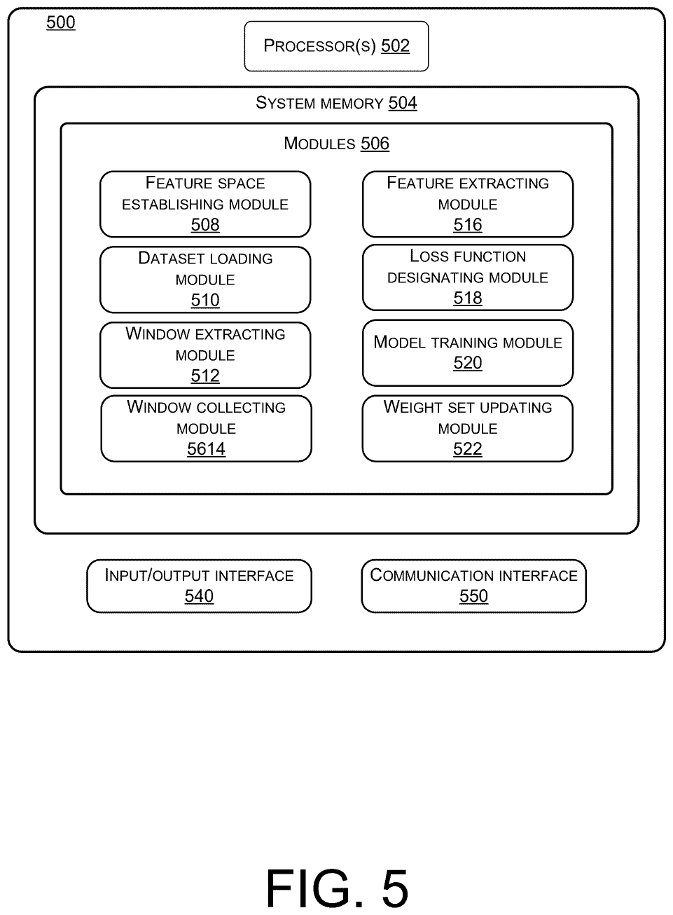

FIG. 5 illustrates an example computing system 500 for implementing the processes and methods described above for implementing learning models and protected training thereof.

The techniques and mechanisms described herein can be implemented by multiple instances of the computing system 500, as well as by any other computing device, system, and/or environment. The computing system 500 can be a distributed system composed of multiple physically networked computers or web servers, a physical or virtual cluster, a computing cloud, or other networked computing architectures providing physical or virtual computing resources as known by persons skilled in the art. Examples thereof include computing hosts as described above with reference to FIG. 1, and learning systems as described above with reference to FIG. 3. The computing system 500 shown in FIG. 5 is only one example of a system and is not intended to suggest any limitation as to the scope of use or functionality of any computing device utilized to perform the processes and/or procedures described above. Other well-known computing devices, systems, environments and/or configurations that can be suitable for use with the examples include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 500 can include one or more processors 502 and system memory 504 communicatively coupled to the processors 502. The processors 502 and system memory 504 can be physical or can be virtualized and/or distributed. The processors 502 can execute one or more modules and/or processes to cause the processors 502 to perform a variety of functions. By way of example, the processors 502 can include one or more general-purpose processors and one or more special-purpose processors. The general-purpose processors and special-purpose processors can be physical or can be virtualized and/or distributed. The general-purpose processors and special-purpose processors can execute one or more instructions stored on a computer-readable storage medium as described below to cause the general-purpose processors or special-purpose processors to perform a variety of functions. General-purpose processors can be computing devices operative to execute computer-executable instructions, such as Central Processing Units (“CPUs”). Special-purpose processors can be computing devices having hardware or software elements facilitating computation of neural network computing tasks such as training and inference computations. For example, special-purpose processors can be accelerators, such as Neural Network Processing Units (“NPUs”), Graphics Processing Units (“GPUs”), Tensor Processing Units (“TPU”), implementations using field programmable gate arrays (“FPGAs”) and application specific integrated circuits (“ASICs”), and/or the like. To facilitate computation of tasks such as matrix multiplication, special-purpose processors can, for example, implement engines operative to compute mathematical operations such as matrix operations and vector operations. Additionally, each of the processors 502 can possess its own local memory, which also can store program modules, program data, and/or one or more operating systems.

Depending on the exact configuration and type of the system 500, the system memory 504 can be volatile, such as RAM, non-volatile, such as ROM, flash memory, miniature hard drive, memory card, and the like, or some combination thereof. The system memory 504 can include one or more computer-executable modules 506 that are executable by the processors 502. The modules 506 can be hosted on a network as services for a data processing platform, which can be implemented on a separate system from the system 500.

The modules 506 can include, but are not limited to, a feature space establishing module 508, a dataset loading module 510, a window extracting module 512, a window collecting module 514, a feature extracting module 516, a loss function designating module 518, a model training module 520, and a weight set updating module 522.

The feature space establishing module 508 can be executable by the processors 502 to establish a feature space for placing a dataset as described above with reference to FIG. 4A.

The dataset loading module 510 can be executable by the processors 502 to load a labeled family dataset into memory as described above with reference to FIG. 4A.

The window extracting module 512 can be executable by the processors 502 to extract windows from a sample of the labeled dataset according to a hyperparameter as described above with reference to FIG. 4A.

The window collecting module 514 can be executable by the processors 502 to collect the set of extracted windows into a data stream as described above with reference to FIG. 4A.

The feature extracting module 516 can be executable by the processors 502 to extract a labeled feature from a set of extracted windows from a sample executable file of the labeled dataset for each label therein as described above with reference to FIG. 4A.

The loss function designating module 518 can be executable by the processors 502 to designate a loss function for placement of the labeled dataset in the feature space as described above with reference to FIG. 4A.

The model training module 520 can be executable by the processors 502 to train the learning model on the designated loss function for placing the labeled dataset in the feature space as described above with reference to FIG. 4A.

The weight set updating module 522 can be executable by the processors 502 to update a weight set (including protected updating) based on a dataset placement learned by the learning model as described above with reference to FIG. 4A.

The computing system 500 can additionally include an input/output (I/O) interface 540 and a communication module 550 allowing the computing system 500 to communicate with other systems and devices over a network, such as the data processing platform, a computing device of a data owner, and a computing device of a data collector. The network can include the Internet, wired media such as a wired network or direct-wired connections, and wireless media such as acoustic, radio frequency (RF), infrared, and other wireless media.

Some or all operations of the methods described above can be performed by execution of computer-readable instructions stored on a computer-readable storage medium, as defined below. The term “computer-readable instructions” as used in the description and claims, include routines, applications, application modules, program modules, programs, components, data structures, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media can include volatile memory (such as random-access memory (“RAM”)) and/or non-volatile memory (such as read-only memory (“ROM”), flash memory, etc.). The computer-readable storage media can also include additional removable storage and/or non-removable storage including, but not limited to, flash memory, magnetic storage, optical storage, and/or tape storage that can provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media can embody computer-readable instructions, data structures, program modules, or other data in a modulated data signal, such as a carrier wave, or other transmission mechanism. As defined herein, computer-readable storage media do not include communication media.

The computer-readable instructions stored on one or more non-transitory computer-readable storage media that, when executed by one or more processors, can perform operations described above with reference to FIGS. 1-4B. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A method comprising:
storing a learning model on local memory of a client computing device;
wherein the learning model configures the client computing device to update an adapter weight set, the learning model and the adapter weight set being protected from outbound network connections of the client computing device; and
wherein the learning model configures the client computing device to place a labeled dataset into a feature space.

2. The method of claim 1, further comprising:
loading the labeled dataset into memory;
designating a loss function for placing the labeled dataset in a feature space;
training a learning model on the designated loss function; and
updating the adapter weight set based on a dataset placement learned by the learning model, wherein the adapter weight set is protected during each epoch at a first layer of the learning model.

3. The method of claim 2, wherein protecting the adapter weight set comprises performing a transformation operation upon the adapter weight set at the first layer.

4. The method of claim 2, wherein protecting the adapter weight set comprises performing a noise injection operation upon the adapter weight set at the first layer.

5. The method of claim 2, wherein a layer of the learning model comprises a rank-deficient coefficient matrix.

6. The method of claim 2, further comprising transmitting the updated adapter weight set to a cloud computing system hosting a hosted foundation model;
wherein the adapter weight set occupies a parameter space of reduced dimensionality relative to a foundation weight set of the hosted foundation model.

7. The method of claim 1, wherein the learning model is structured based on multi-head attention.

8. A system comprising:
one or more processors; and
memory communicatively coupled to the one or more processors, the memory storing a learning model;
wherein the learning model configures the one or more processors to update an adapter weight set, the learning model and the adapter weight set being protected from outbound network connections of the client computing device; and
wherein the learning model configures the one or more processors to place a labeled dataset into a feature space.

9. The system of claim 1, wherein the memory stores computer-executable modules executable by the one or more processors that, when executed by the one or more processors, perform associated operations, the computer-executable modules comprising:
a dataset loading module executable by the one or more processors to load the labeled dataset into memory;
a loss function designating module executable by the one or more processors to designate a loss function for placing the labeled dataset in a feature space;
a model training module executable by the one or more processors to train a learning model on the designated loss function; and
a weight set updating module executable by the one or more processors to update the weight set based on a dataset placement learned by the learning model, wherein the weight set is protected during each epoch at a first layer of the learning model.

10. The system of claim 9, wherein protecting the weight set comprises performing a transformation operation upon the weight set at the first layer.

11. The system of claim 9, wherein protecting the weight set comprises performing a noise injection operation upon the weight set at the first layer.

12. The system of claim 9, wherein a layer of the learning model comprises a rank-deficient coefficient matrix.

13. The system of claim 9, further comprising transmitting the updated adapter weight set to a cloud computing system hosting a hosted foundation model;
wherein the adapter weight set occupies a parameter space of reduced dimensionality relative to a foundation weight set of the hosted foundation model.

14. The system of claim 9, wherein the learning model is structured based on multi-head attention.

15. A method comprising:
receiving, at a cloud computing system, a plurality of trained adapter weight sets updated by respective client computing devices by training respective copies of a private adapter model based on labeled datasets from private threat databases;
training a hosted foundation model based on a labeled dataset from a hosted threat database;
updating the plurality of trained adapter weight sets during the training; and
aggregating the plurality of trained adapter weight sets at a final layer of the hosted foundation model.

16. The method of claim 15, wherein aggregating the plurality of trained adapter weight sets is performed by an order-invariant aggregation function.
